(19) United States
(12) Patent Application Publication
(10) Pub. No.: US 2009/0288331 A1
(43) Pub. Date: Nov. 26, 2009

(54) FISHING EQUIPMENT HOLDER

(76) Inventors: Jesse Moyer, Altoona, PA (US); John Jasper, Cresson, PA (US)

Correspondence Address: JAY M. SCHLOFF, 6960 Orchard Lake Road, Suite 315, West Bloomfield, MI, 48322, US

(21) Appl. No.: 12/470,126

(22) Filed: May 21, 2009

Related U.S. Application Data
(60) Provisional application No. 61/128,206, filed on May 21, 2008.

(51) Int. Cl. A01K 97/06

(52) U.S. Cl. 43/57.1; 43/54.1; 206/350

(57) ABSTRACT

Disclosed is a fishing equipment holder including an elongated hollow member, a covering member and a magnetic member. The elongated hollow member has a proximal end portion and a distal end portion. Further, the elongated hollow member has at least one cut-out at the distal end portion. The covering member is disposed on the proximal end portion of the elongated hollow member for covering the proximal end portion of the elongated hollow member. The covering member is adapted to be secured to an external object. The magnetic member is configured to be received in a space defined between the proximal end portion and the distal end portion of the elongated hollow member. The magnetic member is adapted to be in contact with at least one fishing equipment kept in the at least one cut-out for holding the at least one fishing equipment in the at least one cut-out.

### CROSS REFERENCE TO RELATED APPLICATIONS

The present disclosure claims priority under 35 United States Code, Section 119 on the provisional application No. 61/128,206 filed on May 21, 2008, the disclosure of which is incorporated by reference.

### FIELD OF THE DISCLOSURE

The present disclosure generally relates to the fishing activities, and, more particularly, to a fishing equipment holder for holding fishing equipment used in such activities.

### BACKGROUND OF THE DISCLOSURE

Fishing is an activity to catch fish and other aquatic animals, such as shellfish, cephalopods, crustaceans and echinoderms. Various fishing equipment including, but not limited to, hooks, needles, lines, sinkers, floaters, rods, reels and lures are used in connection with this activity. This equipment is generally available in various sizes, shapes and materials. Individuals are required to utilize the fishing equipment of various sizes, depending upon nature of a particular fishing activity.

Such fishing equipment of various sizes is therefore carried by the individuals in the course of the activity. Some of this fishing equipment, such as lines, sinkers, and rods may be conveniently stored in kits or bags. However, small fishing equipment such as fishing hooks, sinkers and floaters are not easily stored or transported in the kits or the bags, as these small items may get misplaced because of their size, and may be difficult to locate inside the kits or the bags.

Further, some of the small fishing equipment has construction or components that may cause an inadvertent injury to individuals, if such equipment is mishandled. Accordingly, such small fishing equipment is required to be kept at a secure location to avoid any inadvertent injury to the individual. For example, a typical fishing hook includes an eye portion, an elongated shank, and a pointed barb portion. The pointed barb portion of the fishing hooks may pose a threat of harm to the individuals if the fishing hook is mishandled by the individuals. This threat becomes more prominent in the absence of a secure location for storing the hook.

Accordingly, there exists a need for keeping fishing equipment in a readily accessible and a secure location. Further, there exists a need for precluding the fishing equipment from getting misplaced. Furthermore, there exists a need for precluding the fishing equipment from posing an undesired threat to individuals.

### SUMMARY OF THE DISCLOSURE

In view of the foregoing disadvantages inherent in the prior art, the general purpose of the present disclosure is to provide a fishing equipment holder to include all advantages of the prior art, and to overcome the drawbacks inherent in the prior art.

An object of the present disclosure is to keep a fishing equipment in a secure location, thereby precluding the fishing equipment from posing an undesired threat to individuals.

Another object of the present disclosure is to keep a fishing equipment in a readily accessible location in order to preclude the fishing equipment from getting misplaced.

To achieve the above objects, in an aspect of the present disclosure, a fishing equipment holder is provided. The fishing equipment holder includes an elongated hollow member, a covering member and a magnetic member. The elongated hollow member has a proximal end portion and a distal end portion. Further, the elongated hollow member has at least one cut-out at the distal end portion. The covering member is disposed on the proximal end portion of the elongated hollow member for covering the proximal end portion of the elongated hollow member. The covering member is adapted to be secured to an external object. The magnetic member is configured to be received in a space defined between the proximal end portion and the distal end portion of the elongated hollow member. The magnetic member is adapted to be in contact with at least one fishing equipment kept in the at least one cut-out, thereby holding the at least one fishing equipment in the at least one cut-out.

The fishing equipment holder may be utilized by individuals while performing fishing activities. The fishing equipment holder keeps fishing equipment such as fishing hooks or needles, in a readily accessible and a secure location. Therefore, the fishing equipment holder precludes the equipment from posing an undesired threat to the individuals utilizing the fishing equipment. The fishing equipment holder may be attached to an external object such as an article of clothing. Accordingly, the fishing equipment holder precludes the fishing equipment from getting misplaced.

These together with the other aspects of the present disclosure, along with the various features of novelty that characterized the present disclosure, is pointed out with particularity in the claims annexed hereto and forms a part of the present disclosure. For a better understanding of the present disclosure, its operating advantages, and the specified object attained by its uses, reference should be made to the accompanying drawings and descriptive matter in which there are illustrated exemplary embodiments of the present disclosure.

### BRIEF DESCRIPTION OF THE DRAWINGS

The advantages and features of the present disclosure will become better understood with reference to the following detailed description and claims taken in conjunction with the accompanying drawings, wherein like elements are identified with like symbols, and in which:

FIG. 1 illustrates an exploded view of a fishing equipment holder, in accordance with an exemplary embodiment of the present disclosure;

FIG. 2 illustrates a front perspective view of the fishing equipment holder, in accordance with an exemplary embodiment of the present disclosure;

FIG. 3 illustrates a bottom perspective view of the fishing equipment holder, in accordance with an exemplary embodiment of the present disclosure; and

FIG. 4 illustrates a bottom perspective view illustrating an application of the fishing equipment holder, in accordance with an exemplary embodiment of the present disclosure.

Like reference numerals refer to like parts throughout the description of several views of the drawings.

### DETAILED DESCRIPTION OF THE DISCLOSURE

For a thorough understanding of the present disclosure, reference is to be made to the following detailed description, including the appended claims, in connection with the above-described drawings. Although the present disclosure is described in connection with exemplary embodiments, the present disclosure is not intended to be limited to the specific forms set forth herein. It is understood that various omissions and substitutions of equivalents are contemplated as circumstances may suggest or render expedient, but these are intended to cover the application or implementation without departing from the spirit or scope of the claims of the present disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items.

The terms, “a” and “an” herein do not denote a limitation of quantity, but rather denote the presence of at least one of the referenced item.

The present disclosure provides a fishing equipment holder. The fishing equipment holder is capable of keeping fishing equipment, such as fishing hooks, needles, flies, and the like, in a safe manner, thereby precluding the fishing equipments from posing any undesired threat to individuals. Further, the fishing equipment holder provides a means for keeping the fishing equipment in a readily accessible location and, thereby preventing the fishing equipments from getting misplaced.

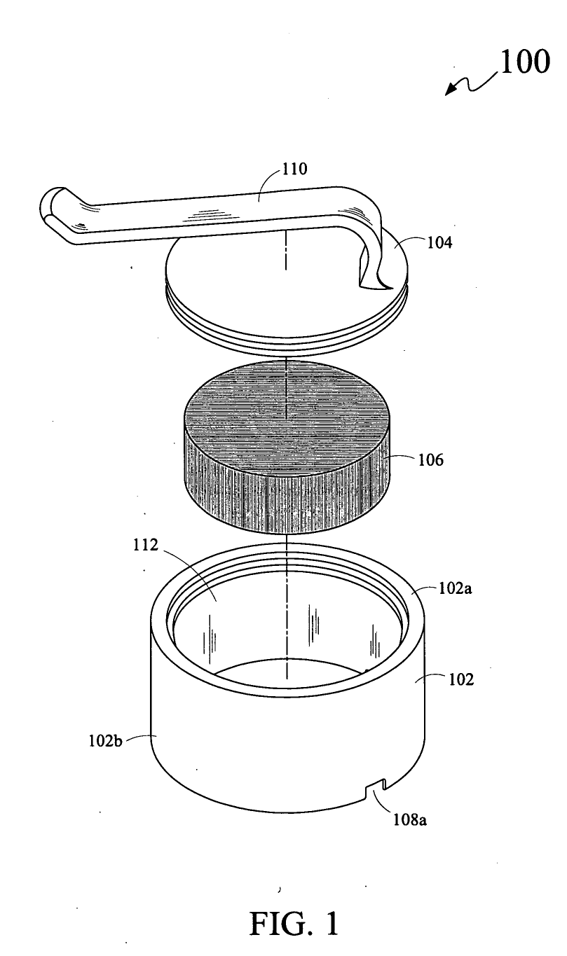

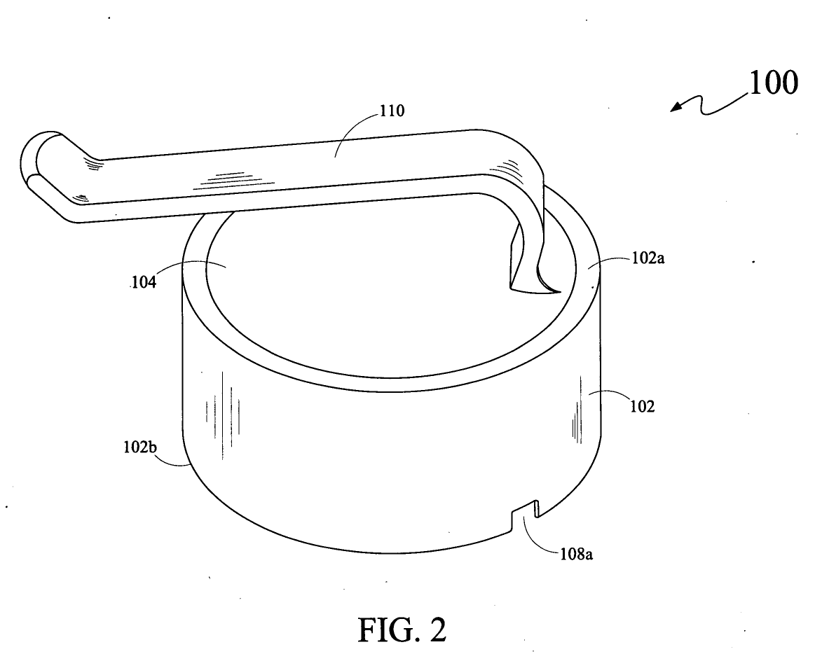

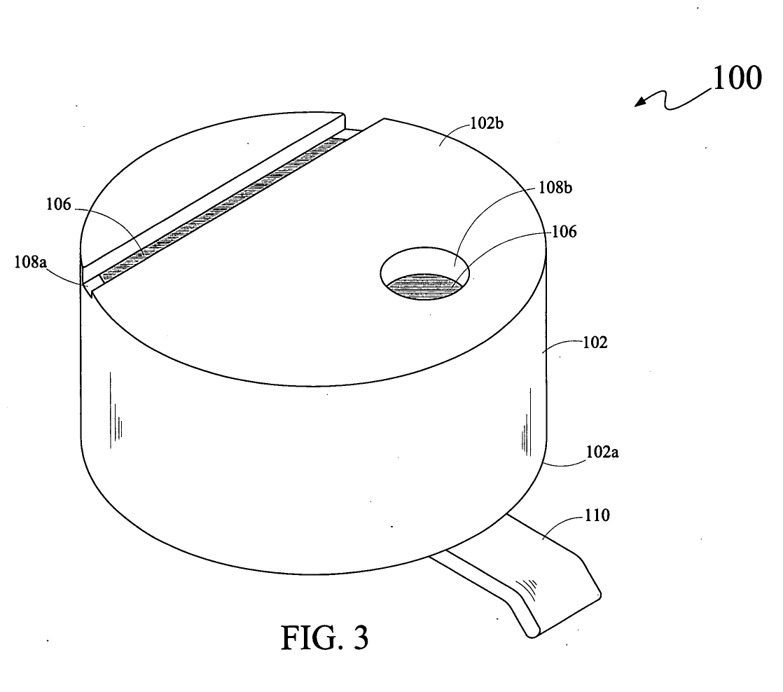

Referring now to FIGS. 1 to 3, a fishing equipment holder 100, is illustrated in accordance with an embodiment of the present disclosure. Specifically, FIG. 1 depicts an exploded view of the fishing equipment holder 100, FIG. 2 depicts a front perspective view of the fishing equipment holder 100, and FIG. 3 depicts a bottom perspective view of the fishing equipment holder 100.

The fishing equipment holder 100 includes an elongated hollow member 102, a covering member 104 and a magnetic member 106. The elongated hollow member 102 includes a proximal end portion 102a and a distal end portion 102b. The elongated hollow member 102 has at least one cut-out such as a first cut-out 108a, and a second cut-out 108b, at the distal end portion 102b. The covering member 104 may be disposed on the proximal end portion 102a of the elongated body member 102. In an embodiment of the present disclosure, the covering member 106 may be detachably attached to the proximal end portion 102a of the elongated hollow member 102.

The detachable attachment of the covering member 106 to the proximal end portion 102a may be provided by suitable mechanisms including, but not limited to, snap fitting attachment or threaded attachment. For example, the covering member 104 may include snap fitting means or threaded means, and the proximal end portion 102a of the elongated hollow member 102 may include complimentary snap fitting means or complimentary threaded means. Accordingly, the covering member 104 may be detachably attached to the proximal end portion 102a. The covering member 104 is shown as detached from the proximal end portion 102a in the exploded view of the fishing equipment holder 100, in FIG. 1. Further, the covering member 104 is shown as disposed on the proximal end portion 102a in the front perspective view of the fishing equipment holder 100, in FIG. 2.

The covering member 104 may be capable of being secured to an external object (not shown). The external object may be an article of clothing such as, a hat, a vest, a shirt, or a belt. However, the external object may also be fishing equipment carriers such as kits and bags. In an embodiment of the present disclosure, as shown in FIG. 1, the covering member 104 includes at least one means of attachment, such as a clip member 110 for securing the covering member 104 to the external object. The clip member 110 is adapted to be detachably attached to the external object. However, it should be evident to a person skilled in the art that, other means of attachment, such as a snap-fit mechanism, a Velcro mechanism, and the like may also be utilized for the purpose of securing the covering member 104 to the external object.

The magnetic member 106 is configured to be received in a space 112 defined between the proximal end portion 102a and the distal end portion 102b of the elongated hollow member 102. The magnetic member 106 is shown as a single piece of magnet in FIG. 1; however, it should be evident to a person skilled in the art that more that one magnetic member may be received in the space 112. Further, the magnetic member 106 is depicted as circular in shape, however it would be apparent to those ordinary skilled in the art that the magnetic member 106 may be of any other suitable shape. The magnetic member 106 is received in the space 112 inside the elongated hollow member 102, and therefore the magnetic member 106 is not visible in FIG. 2.

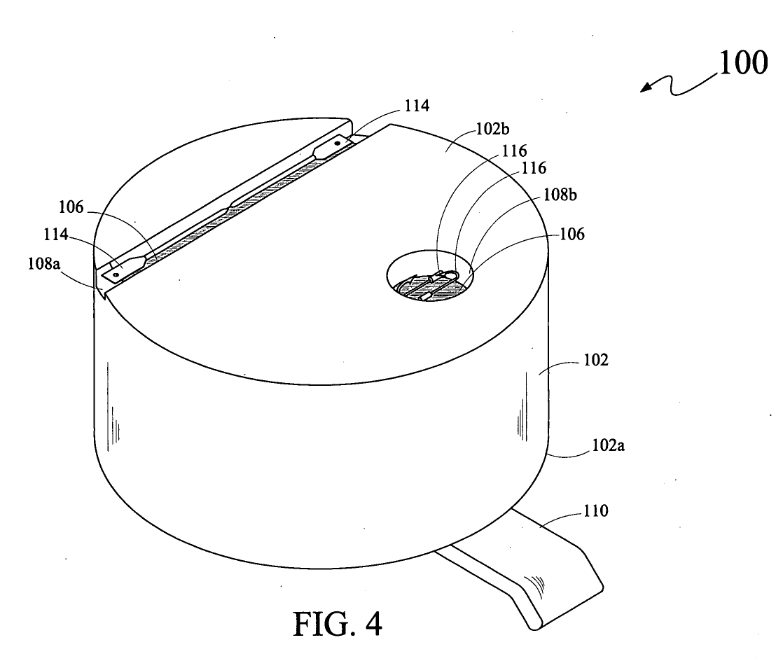

The at least one cut-out such as the first cut-out 108a and the second cut-out 108b, of the elongated hollow member 102 are capable of being utilized for placing the fishing equipment thereon. Specifically, each of the first cut-out 108a and the second cut-out 108b provide a space where the fishing equipment may be kept. The fishing equipment kept in the first cut-out 108a and the second cut-out 108b are in contact with the magnetic member 106. The first cut-out 108a and the second cut-out 108b represented in FIG. 3 are for exemplary purposes only, and the configuration of the first cut-out 108a and the second cut-out 108b should not be considered as limiting. For example, the first cut-out 108a and the second cut-out 108b may be configured to have various shapes, such as a circular shape and a rectangular shape. In an embodiment of the present disclosure, the first cut-out 108a is a channel or a groove; and the second cut-out 108b is a hole. Further, it should be evident to a person skilled in the art that the distal end portion 102b of the elongated hollow member 120 may include fewer or more cut-outs, instead of two cut-outs as illustrated and described herein. Furthermore, one exemplary application of the fishing equipment holder 100 keeping fishing equipment is explained in conjunction with FIG. 4.

Referring now to FIG. 4, a bottom perspective view of the fishing equipment holder 100 is shown in a utilized state, in accordance with an embodiment of the present disclosure. More specifically, as shown in FIG. 4, at least one fishing equipment such as, fishing needles 114 and fishing hooks 116, is kept on the fishing equipment holder 100. For example, as shown, the fishing needles 114 are kept in the first cut-out 108a. Similarly, as shown, the fishing hooks 116 are kept in the second cut-out 108b. Generally, fishing equipment is composed of metals and their alloys, such as high-carbon steel, stainless steel and the like. Therefore, the fishing equipment may be attracted towards magnets.

It would be apparent to those ordinary skilled in the art that the magnetic member 106 is capable of applying a magnetic force on the fishing needles 114, and the fishing hooks 116. Specifically, when the fishing needles 114 and the fishing hooks 116 come in contact with the magnetic member 106 upon being kept in the first cut-out 108a and the second cut-out 108b, respectively. Accordingly, the magnetic force applied by the magnetic member 106 is capable of keeping the fishing needles 114 and fishing hooks 116 in place in the first cut-out 108a and the second cut-out 108b, respectively. Therefore, it will be evident to those ordinary skilled in the art that the at least one cut-out provides a readily accessible and a secure location for placing the at least one fishing equipment. Further, the placement of the fishing needles 114 and the fishing hooks 116 in the first cut-out 108a and the second cut-out 108b, respectably, precludes the fishing needles 114 and fishing hooks 116 from being misplaced, and from posing an undesired threat to the individuals.

The present disclosure provides a fishing equipment holder such as the fishing equipment holder 100 in various configurations and arrangements. In one embodiment the covering member 104 is detachably attached to the elongated hollow member 102, for example the covering member 104 may be snap fitted on the elongated hollow member 102. Such exploded view of these components is explained in conjunction with FIG. 1. However, in another embodiment, the covering member 104 may be permanently attached to the elongated hollow member 102. More specifically, in this embodiment of the present disclosure, the covering member 104 may be an inbuilt part of the elongated hollow member 102. It would be apparent to those skilled in the art that during the manufacturing of the fishing equipment holder, a magnetic member such as the magnetic member 106 may be stored inside the elongated hollow member 102. In another embodiment of the present disclosure the distal end portion 102b of the elongated hollow member 102 may be detachably attached to the elongated body member 102.

Further, shapes and configurations of various components of the fishing equipment holder 100 should not be contemplated as limiting by the representations made in FIGS. 1-4, as these representations are for exemplary purposes only. For example, the elongated hollow member 102 may be of shapes such as circular and polygonal. In an exemplary embodiment of the present disclosure, the elongated hollow member 102 may be cylindrical in shape having a diameter of two inches and a height of half inch. Furthermore, the elongated hollow member 102, and covering member 104 may be composed of a suitable durable material, such as a plastic material.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

What is claimed is:

1. A fishing equipment holder, comprising:
an elongated hollow member having a proximal end portion and a distal end portion, the elongated hollow member having at least one cut-out at the distal end portion;
a covering member disposed on the proximal end portion of the elongated hollow member for covering the proximal end portion of the elongated hollow member, the covering member adapted to be secured to an external object; and
a magnetic member configured to be received in a space defined between the proximal end portion and the distal end portion of the elongated hollow member, the magnetic member adapted to be in contact with at least one fishing equipment kept in the at least one cut-out, thereby holding the at least one fishing equipment in the at least one cut-out.

2. The fishing equipment holder of claim 1, wherein the elongated hollow member is composed of a plastic material.

3. The fishing equipment holder of claim 1, wherein the covering member is composed of a plastic material.

4. The fishing equipment holder of claim 1, wherein the covering member is detachably attached to the proximal end portion of the elongated hollow member.

5. The fishing equipment holder of claim 1, wherein the covering member comprises a clip adapted to be secured to the external object.

6. The fishing equipment holder of claim 1, wherein the at least one cut-out is at least one groove.

7. The fishing equipment holder of claim 1, wherein the at least one cut-out is at least one hole.
